(19) United States
(12) Patent Application Publication
(10) Pub. No.: US 2007/0053077 A1
(43) Pub. Date: Mar. 8, 2007

(54) Customer illumination aperture structure

(76) Inventors: Ling-Chieh Lin, Taichung County (TW); I-Hsiung Huang, Hsinchu County (TW); Te-Hung Wu, Tainan County (TW); Chin-Lung Lin, Hsinchu City (TW)

Correspondence Address: J C PATENTS, INC., 4 VENTURE, SUITE 250, IRVINE, CA, 92618, US

(21) Appl. No.: 11/218,454

(22) Filed: Sep. 2, 2005

(51) Int. Cl. G02B 9/00; G02B 9/08

(52) U.S. Cl. 359/738

(57) ABSTRACT

A customer illumination aperture (CIA) structure for lithographic exposure is disclosed, including a central part and at least one off-axis part around the central part. The off-axis part of the CIA is disposed in a symmetric manner with respect to the central part.

### BACKGROUND OF THE INVENTION

1. Field of the Invention

The present invention relates to the lithographic technology. More particularly, the present invention relates to a customer illumination aperture (CIA) structure for lithographic exposure, which can improve the resolution in simultaneous formation of dense, semi-dense and isolated patterns.

2. Description of the Related Art

In advanced semiconductor processes, especially those of 90 nm generation or below, resolution-enhanced technologies (RET) are required to achieve fine pitch resolution. Many methods have been proposed to overcome the issue of lower k1 value, such as, the methods using alternating phase-shift masks (Alt-PSM), chromeless masks, vertex masks or half-tone masks in exposure, and multiple exposure methods.

Other RET methods include judicious applications of mask biasing and inclusion of additional assisting features. However, these methods suffer from high cost and low throughput on mask manufacturing since circuit designs are often too complex to be handled by optical proximity correction (OPC) software.

Another RET method is to use optimal customer illumination apertures (CIAs), as described in U.S. Pat. No. 6,839,125. For example, the illumination aperture of FIG. 1 having one ring-shaped off-axis part 110 is often applied between the exposure light source and the photomask. However, such an illumination aperture is not so good in definition of isolated and semi-dense patterns.

### SUMMARY OF THE INVENTION

In view of the foregoing, this invention provides a customer illumination aperture (CIA) structure for lithographic exposure, which can improve the resolution in simultaneous formation of dense, semi-dense and isolated patterns.

The CIA structure of this invention includes a central part and at least one off-axis part around the central part. The at least one off-axis part is disposed in a symmetric manner with respect to the central part.

In the above CIA structure of this invention, the central part may have a ring shape. The off-axis part may be a single region having a ring shape, or includes a number “n” (n≧2) of regions arranged in n-fold symmetry around the central part. In addition, there may be multiple off-axis parts arranged in two or more circles around the central part. Combinations of two or all of the three additional features are also allowed.

Since the central part is good for definition of isolated and semi-dense patterns and the off-axis part good for that of dense patterns, the overall quality of pattern transfer can be improved. By comparing the simulated aerial images and the real resist profiles obtained in experiments, it is confirmed that the through-pitch CD uniformity, mask error enhancement factor (MEEF), line-end shortening problem, pattern linearity and depth of focus (DOF) can be improved by using the illumination aperture of this invention with reduced OPC loading and cost.

It is to be understood that both the foregoing general description and the following detailed description are exemplary, and are intended to provide further explanation of the invention as claimed.

### BRIEF DESCRIPTION OF THE DRAWINGS

FIG. 1 illustrates a CIA structure in the prior art.

FIGS. 2-4 illustrate three examples of CIA structure of this invention, wherein each off-axis part is a single region having a ring shape.

FIGS. 5A-5D illustrate four more examples of CIA structure of this invention, wherein the off-axis part include n regions (n≧2) arranged in n-fold symmetry.

FIGS. 6 illustrates another exemplary CIA structure of this invention, wherein the off-axis part includes 3 regions arranged in 3-fold symmetry that are connected with the central part.

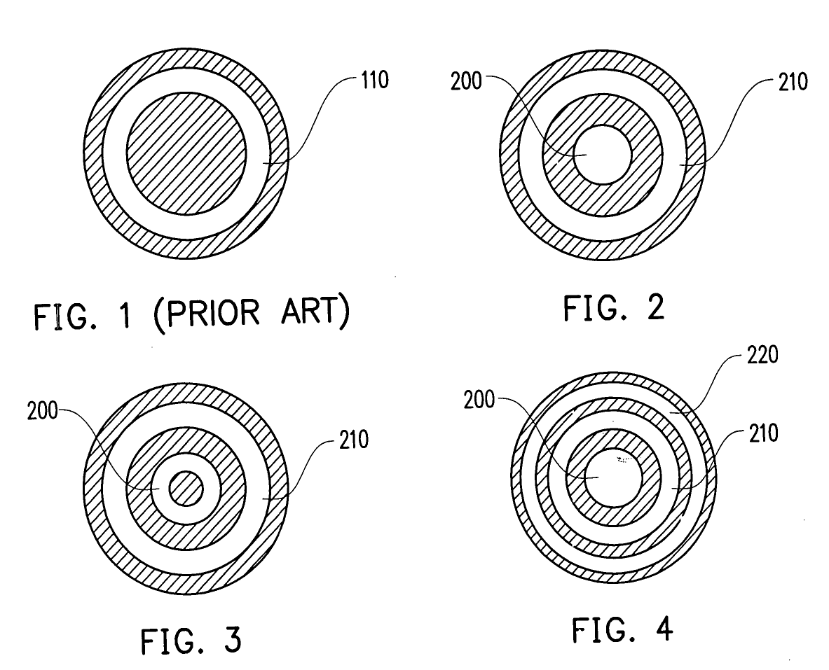

### DESCRIPTION OF THE PREFERRED EMBODIMENTS

FIGS. 2-4 illustrate three examples of CIA structure of this invention, wherein each off-axis part is a single region having a ring shape.

Referring to FIG. 2, the CIA structure of this example includes a solid central part 200 and an off-axis part 210, which is a single region having a ring shape around the central part 200. Referring to FIG. 3, the central part 200 in the CIA structure may also have a ring shape.

Moreover, there may be more than one off-axis parts arranged in two or more circles around the central part 200, wherein any off-axis part can be a single region having a ring shape or includes n regions (n≧2) arranged in n-fold symmetry. As shown in FIG. 4, there are a first off-axis part 210 around the central part 200 and a second off-axis part 220 around the first one 210, wherein each of the first and second off-axis parts 210 and 220 can be a single region having a ring shape.

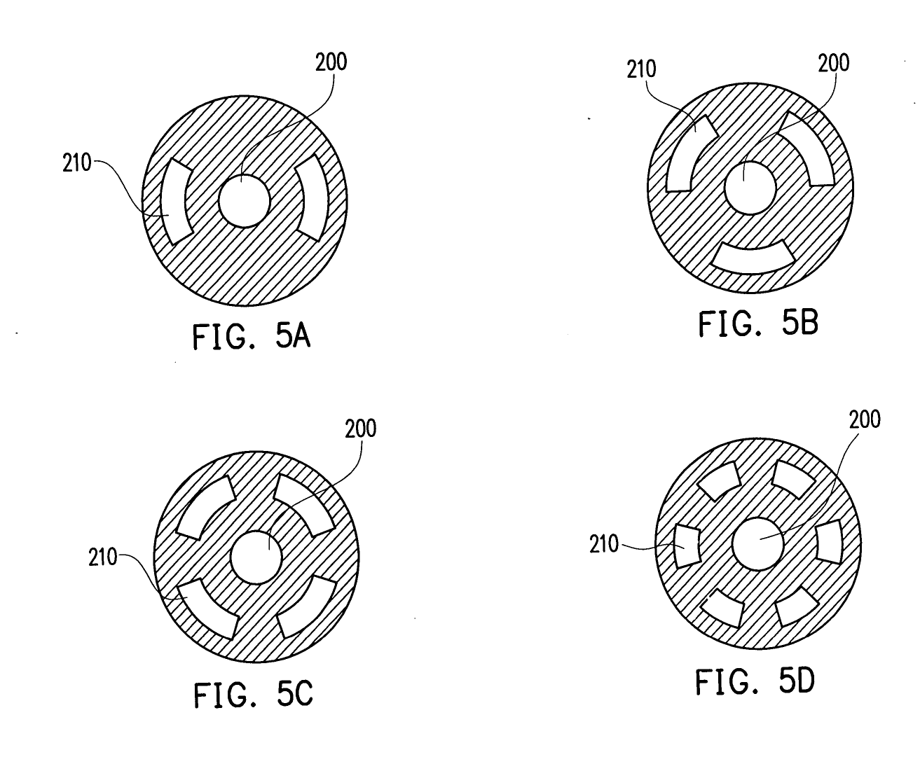

FIGS. 5A-5D illustrate four more examples of CIA structure of this invention, wherein the off-axis part include n regions (n≧2) arranged in n-fold symmetry. The n regions are preferably shaped such that they can be covered by an imaginary ring region around the central part 200, and n is preferably an integer between 2 and 6. For example, the two, three, four or six regions of the off-axis part 210 in FIG. 5A, 5B, 5C or 5D can be covered by an imaginary ring region corresponding to the off-axis part 210 of single-ring shape in FIG. 2. In real applications, the n regions (n≧2) of the off-axis part 210 can be made by, for example, forming a ring-shaped aperture and then disposing a corresponding number of screen plates in n-fold symmetry to divide the ring-shaped aperture into n regions, as described in U.S. Pat. No. 6,839,125.

Referring to FIG. 5A, the off-axis part 210 includes two regions that are arranged in 2-fold symmetry. The two regions are preferably arranged in x- or y-direction. When the two regions are arranged in x-direction, the x-directional resolution obtained is better than that obtained with the CIA structure of FIG. 2, but the y-directional resolution is worse relatively. Moreover, when the x-direction effect is too strong, the hole patterns in the photoresist layer will be distorted to lower the symmetricity thereof.

Referring to FIG. 5B, the off-axis part 210 includes three regions that are arranged in 3-fold symmetry. When such a CIA structure is used, both the centroid and the symmetricity of the photoresist patterns can be maintained well.

Referring to FIG. 5C, the off-axis part 210 includes four regions that are arranged in 4-fold symmetry. In the illustrated example, the four regions are arranged in ±y-directions. When such a CIA structure is used, the x-directional resolution obtained is better than that obtained with the CIA structure of FIG. 2, but is worse than that obtained with the CIA structure of FIG. 5A. However, the hole patterns in the photoresist layer will not be distorted when the CIA structure of FIG. 5C is adopted, because there is little x-direction effect caused by this CIA structure.

Referring to FIG. 5D, the off-axis part 210 includes six regions that are arranged in 6-fold symmetry. The width of one region in the circumferential direction of the circle is preferably larger than the distance between two regions.

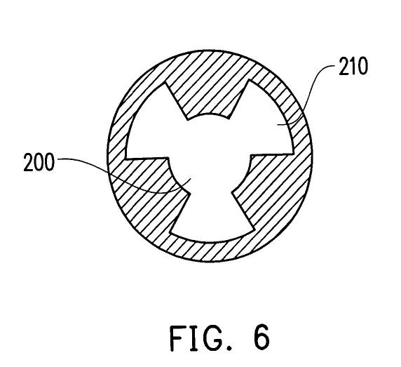

Furthermore, when the off-axis part include n regions in n-fold symmetry, the n regions of the off-axis part may be connected with the central part of the CIA structure, as shown in FIG. 6, where the off-axis part 210 include three regions in 3-fold symmetry that are connected with the central part 200.

In addition, any combination of two or al! of the three features about the shape of the central part 200, the number of off-axis parts and the geometry (single or n regions) of an off-axis part is also possible, depending on the shapes and arrangements of the patterns to be transferred to the photoresist layer.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A customer illumination aperture (CIA) structure for lithographic exposure, comprising:
a central part; and
at least one off-axis part around the central part, disposed in a symmetric manner with respect to the central part.

2. The CIA structure of claim 1, wherein the central part has a ring shape.

3. The CIA structure of claim 1, wherein the off-axis part is a single region having a ring shape.

4. The CIA structure of claim 1, wherein the off-axis part includes a number “n” (n≧2) of regions that are arranged in n-fold symmetry around the central part.

5. The CIA structure of claim 4, wherein n is equal to any integer of 2 to 6.

6. The CIA structure of claim 4, wherein the n regions are connected with the central part.

7. The CIA structure of claim 4, wherein the n regions are shaped such that they can be covered by an imaginary ring region around the central part.

8. The CIA structure of claim 1, wherein there is a plurality of off-axis parts arranged in two or more circles around the central part.

9. The CIA structure of claim 8, wherein at least one of the off-axis parts has a ring shape.

10. The CIA structure of claim 1, further having two or all of the following three features including:
the central part having a ring shape;
there being a plurality of off-axis parts arranged in two or more circles around the central part; and
at least one off-axis part including a number “n” (n≧2) of regions arranged in n-fold symmetry around the central part.
